(19) United States
(12) Patent Application Publication
(10) Pub. No.: US 2026/0267445 A1
(43) Pub. Date: Sep. 10, 2026

(54) SENSOR AND METHOD FOR OPERATING THE SENSOR

(71) Applicant: AMS-OSRAM AG, Premstaetten (AT)

(72) Inventors: Johannes WILD, Obertraubling (DE); Tim BOESCKE, Regensburg (DE); Christoph KUCH, Fahrenzhausen (DE); Michael HIRMER, Wiesent (DE)

(21) Appl. No.: 19/163,860

(22) PCT Filed: Mar. 12, 2024
(86) PCT No.: PCT/EP2024/056528

§ 371 Date: Sep. 10, 2025

(30) Foreign Application Priority Data
Mar. 15, 2023 (DE) 10 2023 106 482.7

(51) Int. Cl. G06F 3/042; G06F 3/01; G06F 3/041

(52) U.S. Cl. CPC G06F 3/0421; G06F 3/017; G06F 3/0414

(57) ABSTRACT

An all-optical sensor for detecting gesture inputs and force inputs is specified, the sensor including at least two emitter-detector pairs including a first emitter-detector pair and a second emitter-detector pair, each emitter-detector pair of the sensor including an emitter and a detector, and a partially reflective and partially light-transmissive reflector. Furthermore, a method for operating the sensor is specified.

### CROSS-REFERENCE TO RELATED APPLICATIONS

This application is a 371 U.S. National Phase of PCT International Patent Application No. PCT/EP2024/056528 filed on Mar. 12, 2024, which claims priority from German Patent Application No. 10 2023 106 482.7 dated Mar. 15, 2023, the disclosures of which are incorporated by reference herein in their entirety for all purposes.

### BACKGROUND OF THE INVENTION

In the prior art, gestures above a surface and forces applied to a surface are usually measured with different sensors leading to multiple optical/non-optical sensor combinations. For instance, prior art document US 2020/0 100 013 A1 discloses an earphone having a capacitive force input, and prior art documents U.S. Pat. Nos. 10,215,857 B2 and 11,402,202 B2 disclose optical proximity sensors.

### SUMMARY OF THE INVENTION

A sensor and a method for operating the sensor are specified. The sensor may be an all-optical sensor for detecting gesture inputs and force inputs and the method for operating the sensor is a method for operating the sensor for detecting gesture inputs and force inputs.

At least one object of particular embodiments is to provide a sensor. A further object of particular embodiments is to provide a method for operating the sensor.

These objects are achieved by the subject-matter and the method according to the independent claims. Advantageous embodiments and developments of the subject-matter and the method are characterized in the dependent claims, and are also disclosed by the following description and the drawings.

According to at least one embodiment, a sensor comprises a first emitter-detector pair and a second emitter-detector pair. Each of the emitter-detector pairs comprises an emitter, configured to emit a sensor light, and a detector, configured to detect the sensor light and to produce an intensity signal. Furthermore, the sensor comprises a reflector.

According to at least one further embodiment, in a method for operating the sensor the sensor is used.

Embodiments and features described here and in the following equally relate to the sensor and to the method for operating the sensor.

The sensor may be an all-optical sensor. This can, in particular, mean that the sensor is free of non-optical sensor devices like capacitive sensors and piezoelectric sensors. Particularly, the sensor is configured for detecting gesture inputs and force inputs and the method for operating the sensor is a method for operating the sensor for detecting gesture inputs and force inputs.

Here and in the following, a “gesture input” can be an input caused by an object, for instance a user's hand or finger, that is present in the field of illumination of the sensor, which means that sensor light emitted by the sensor can be irradiated on the object, can be reflected by the object and can be detected by the sensor. For example, the object can appear and then disappear over the sensor and/or can move relative to the sensor, in particular in the field of illumination, so that the sensor-light reflection caused by the object changes over time, which can cause varying detection signals in the sensor. Furthermore, a “force input” can be understood as an input caused by an object that applies a force to the reflector so that the reflector is bent and/or moved, so that the reflection characteristics, for instance a reflection direction, of the reflector is changed. Detection signals of the sensor can, in particular, be intensity signals produced by one or more or all detectors of the sensor.

According to a further embodiment, the sensor comprises at least two emitter-detector pairs comprising the first emitter-detector pair and the second emitter-detector pair. The emitter of each emitter-detector pair is configured to emit a sensor light with a main emission direction that is parallel or at least substantially parallel to a vertical direction. The detector of each emitter-detector pair is configured to detect the sensor light emitted by the emitter of the same emitter-detector pair. The sensor light emitted by the emitters of the emitter-detector pairs can be the same or can be different.

Each of the emitter-detector pairs is defined by an emitter and a detector. The emitter and detector of each of the emitter-detector pairs form a logical unit. The emitter-detector pairs can share a same emitter or share a same detector. In other words, one emitter can be part of two emitter-detector pairs or one detector can be part of two emitter-detector pairs. Particularly, the sensor can comprise a single emitter as the only emitter of the sensor and at least two detectors, so that all emitter-detector pairs share the same emitter, or the sensor can comprise a single detector as the only detector of the sensor and at least two emitters, so that all emitter-detector pairs share the same detector.

For example, the sensor can comprise at least one emitter and at least a first detector and a second detector, wherein the at least one emitter and the first detector form the first emitter-detector pair and the at least one emitter and the second detector form the second emitter-detector pair. In other words, the first emitter-detector pair and the second emitter-detector pair can share the same emitter. The at least one emitter can be configured to continuously emit the sensor light during operation of the sensor or can emit light pulses.

Alternatively, the sensor can comprise a first emitter and a second emitter and at least one detector, wherein the first emitter and the at least one detector form the first emitter-detector pair and the second emitter and the at least one detector form the second emitter-detector pair. In other words, the first emitter-detector pair and the second emitter-detector pair can share the same detector. The first and second emitter can be configured to emit light pulses or frequency-modulated light with different frequencies. Each of the first and second emitters can be configured to emit light pulses of the same sensor light, i.e. sensor light with the same wavelength, and the first emitter can emit the light pulses at different times than the second emitter.

According to a further embodiment, it is not necessary that the emitter and the detector of each of the emitter-detector pairs form an integrated device. In contrast, it can be possible that the emitter and the detector of an emitter-detector pair are separate components that are mounted on a common carrier of the sensor. Furthermore, for instance all detectors of the sensor can be part of a single integrated component, for example formed by a plurality of detectors mounted on a common submount or by a pixilated detector, wherein the integrated component can, in turn, be mounted on a carrier on which also at least one emitter is mounted. It can also be possible that all emitters of the sensor form a single integrated component, for instance formed by a plurality of emitters mounted on a common submount or by a pixilated emitter, wherein the integrated component can, in turn, be mounted on a carrier on which also at least one detector is mounted.

The vertical direction, which, as described above, is or at least substantially corresponds to the emission direction of the at least one emitter, can be a direction perpendicular to a mounting surface on which the emitter-detector pairs are arranged. Lateral directions can be directions that are perpendicular to the vertical direction. Consequently, the emitter and detector of each of the emitter-detector pairs are arranged along a lateral direction and so that the emitter and detector of each of the emitter-detector pairs have a distance to each other that is measured along that lateral direction. The distance between the emitter and detector of each of the emitter-detector pairs is also denoted as baseline in the following. Hence, the first emitter-detector pair of the sensor has a first baseline and the second emitter-detector pair of the sensor has a second baseline, wherein the baseline of each of the emitter-detector pairs is defined by a distance in a lateral direction between the emitter of the emitter-detector pair and the detector of the same emitter-detector pair. The first baseline may be different from the second baseline.

According to a further embodiment, the reflector is partially reflective and partially light-transmissive for the sensor light emitted by all of the emitters of the sensor. In other words, the reflector partly reflects and partly transmits the sensor light emitted by each of the emitters of the sensor.

According to a further embodiment, the reflector is arranged, along the vertical direction, over all emitter-detector pairs of the sensor. The reflector comprises a surface facing the emitter-detector pairs, from which sensor light emitted by an emitter can be reflected to a detector. In particular, in an idle state of the sensor, the reflector is arranged at a certain distance from the emitter-detector pairs measured along the vertical direction. The idle state of the sensor can be a state in which the sensor and, in particular, the reflector is not influenced by an external object. In particular, in the idle state the reflector is not touched or pressed by an external object like a user's hand or finger. Consequently, the reflector has a first height along the vertical direction in the idle state of the sensor. For instance, the height of the reflector can be measured along the vertical direction from a mounting surface, onto which the emitter-detector pairs are mounted, or from an emission surface of the emitter and/or from a detection surface of the detector of each of the emitter-detector pairs or from an upper surface, i.e. a surface that faces the reflector, of a casting that encapsulates the emitter-detector pairs.

During operation of the emitter-detector pairs in the idle state of the sensor, for the first emitter-detector pair a first part of the sensor light emitted by the emitter of the first emitter-detector pair is reflected by the reflector onto the detector of the first emitter-detector pair and the detector of the first emitter-detector pair produces a first intensity signal, and for the second emitter-detector pair a second part of the sensor light emitted by the emitter of the second emitter-detector pair is reflected by the reflector onto the detector of the second emitter-detector pair and the detector of the second emitter-detector pair produces a second intensity signal.

Accordingly, in the method for operating the sensor the first emitter-detector pair and the second emitter-detector pair are operated at the same time or subsequently, so that the first emitter-detector pair produces the first intensity signal having a first signal strength and the second emitter-detector pair produces the second intensity signal having a second signal strength. The first intensity signal is observed for changes in the first signal strength and the second intensity signal is observed for changes in the second signal strength. Observing a signal for changes in a signal strength can in particular mean that signal strength variations with time are observed. Furthermore, a difference signal of the first intensity signal and the second intensity signal is calculated and the difference signal is observed for changes in a difference signal strength.

When a force input occurs, which can mean that an object presses onto the reflector so that the height of at least a part of the reflector decreases from the first height to a second height that is less than the first height, the first part of the first sensor light and the second part of the second sensor light change due to the change in the geometrical relation between the reflector and the emitters and detectors of the emitter-detector pairs. The first height of the reflector, the first baseline of the first emitter-detector pair and the second baseline of the second emitter-detector pair may be chosen so that, when the whole reflector or at least a part of the reflector is moved from the first height to a second height that is less than the first height, the first part of the sensor light is increased and the second part of the sensor light is decreased.

According to a further embodiment, the first baseline determines a first characteristic proximity curve defining a dependency of the first intensity signal from the height of the reflector and the second baseline determines a second characteristic proximity curve defining a dependency of the second intensity signal from the height of the reflector. In order to achieve the before-mentioned changes in the first and second intensity signal strengths, the first characteristic proximity curve has a maximum at a height that is less than the first height and may be less than the second height, and the second characteristic proximity curve has a maximum at a height that is greater than the first height.

Consequently, when the reflector or at least a part of the reflector is at the second height, more sensor light is irradiated onto the detector of the first emitter-detector pair and less sensor light is irradiated onto the detector of the second emitter-detector pair as compared to the idle state. Thus, when the reflector or at least a part of the reflector is at the second height, the first signal strength of the first intensity signal of the first emitter-detector pair is increased and the second signal strength of the second intensity signal of the second emitter-detector pair is decreased. Consequently, in the difference signal of the first intensity signal and the second intensity signal, the changes in the first and second signal strength sum up and do not cancel each other out, so that the change in the difference signal strength is greater than the changes in the first and second intensity signal strengths. Thus, a force input on the reflector that causes a height change of the reflector or at least a part of the reflector can be identified by comparing the difference signal to the first and second intensity signals.

When a gesture input occurs, which means that an object is present over or on the reflector, as seen from the emitter-detector pairs, but does not press onto the reflector and, thus, does not reduce the height of the reflector or of at least a part of the reflector, at least a part of the sensor light that is transmitted through the reflector can be reflected by the object back through the reflector and onto the detector of the emitter-detector pairs. Consequently, in comparison to a state of the sensor where the object is absent, more sensor light is irradiated onto the detector of the first emitter-detector pair and more sensor light is irradiated onto the detector of the second emitter-detector pair. Thus, in the difference signal of the first intensity signal and the second intensity signal, the changes in the first and second signal strength at least partly cancel each other out, so that the amplitude of the change in the difference signal strength is smaller than the amplitudes of the changes in the first and second intensity signals.

According to a further embodiment, at least one emitter of the sensor or more than one emitter or all emitters of the sensor, which can be one or more emitters, is a vertically-emitting laser diode. Furthermore, at least one emitter of the sensor or more than one emitter or all emitters of the sensor, which can be one or more emitters, is a light-emitting diode. The sensor light emitted by the one or more or all emitters of the sensor can have a spectral component in the infrared, visible and/or ultraviolet wavelength range. In particular, the sensor light can be infrared light or visible light or ultraviolet light. Furthermore, at least one detector of the sensor or more than one detector or all detectors of the sensor, which can be one or more detectors, is a photodiode. All emitters and all detectors of the sensor may be arranged in such a way that no emitter can directly irradiate sensor light onto any detector.

According to a further embodiment, the reflector comprises a plate-like part or is formed as a plate. For instance, the reflector can be a cover lid arranged over the emitter-detector pairs, so that at least a part of the reflector can change its height. Particularly, the reflector can be bent by a user and/or moved by a user, in particular towards the emitter-detector pairs, so that a force input can cause a change in height of at least a part of the reflector. The reflector can comprise a plastic or can be made of plastic, for instance ABS (acrylonitrile butadiene styrene).

According to a further embodiment, the reflector has a reflectivity equal to or greater than 75% and equal to or less than 99% for the sensor light emitted by at least one emitter, which can be one or more emitters. In some embodiments, the reflector has a reflectivity equal to or greater than 75% and equal to or less than 99% for the sensor light emitted by all emitters of the sensor. Furthermore, the reflector has a light-transmission of equal to or greater than 1% and equal to or less than 25% for the sensor light.

Although the above description is mostly related to two emitter-detector pairs, i.e. a first emitter-detector pair and a second emitter-detector pair, the sensor can have more than two emitter-detector pairs, for instance three emitter-detector pairs, four emitter-detector pairs, five emitter-detector pairs, six emitter-detector pairs or ten emitter-detector pairs. It can also be advantageous when the sensor comprises a first group of at least two first emitter-detector pairs, wherein all first emitter-detector pairs of the first group have the same first baseline, and a second group of at least two second emitter-detector pairs, wherein all second emitter-detector pairs of the second group have the same second baseline. Particularly, all emitter-detector pairs of a group can have the same or at least substantially the same characteristic proximity curve. More than one emitter-detector pair with the same baseline and, in particular, the same characteristic proximity curve can lead to certain degree of redundancy and/or an increase of the signal-to-noise ratio. In particular, all emitter-detector pairs can share the same emitter or all emitter-detector pairs can share the same detector. By using more than two emitter-detector pairs in the sensor, the above-mentioned effects for detecting force and gesture inputs can be improved.

In particular, according to several embodiments, the sensor and the method can comprise for instance one or more of the following features. The sensor has at least one emitter that emits sensor light at a specific wavelength and has more than one detector at several positions with different predetermined emitter-detector baselines. A reflector can be placed above the emitter, wherein the reflector has a certain predetermined non-zero transmission at the specified sensor light wavelength. The sensor is optimized so that at least one emitter detector pair is on the left side and at least one emitter-detector pair is on the right side of the characteristic proximity curve in the idle reflector position. In another advantageous configuration at least two emitters, which can emit the same sensor light, are used with a single detector. The emitters can send out, one after the other in a certain time sequence, light pulses that are detected by the detector, so that the different emitter signals can be identified. With different emitter detector baselines different predetermined characteristic proximity curves as described before can be realized.

The reflector is part of the sensor and can form the interface surface with a user. The sensor can distinguish between a displacement and/or deformation of the reflector due to a force input and one or more objects above the reflector that can be a gesture input. A displacement and/or deformation of the reflector towards the emitter-detector pairs, by applying force to the reflector surface, will lead to an increasing signal strength for detectors of emitter-detector pairs on the right side of the proximity peak and to a decreasing signal strength for detectors of emitter-detector pairs on the left side of the proximity peak. Objects above the reflector can lead to an increasing strength for all emitter-detector pairs. By triangulation of detected signals one can extract two different measures: reflector displacement and/or deformation as well as location of objects above the reflector. Forces applied to the surface can be calculated from the reflector displacement/deformation signal.

In contrast to the sensor described herein, existing force Sensors are mostly realized by capacitive or piezoelectric sensors. The precision of those sensors is often not very high and/or depends on external parameters like temperature and humidity. The sensor described herein can be used instead of a combination of several sensors with different working principles and can increase the precision and robustness at least of the force measurement.

The sensor described herein can provide the advantage that only a single all-optical sensor is used to detect both force inputs on the reflector and gesture inputs above the surface. Both gesture and force inputs can be evaluated in a single measurement. A very small form factor can be possible that can allow the sensor to be integrated into applications like earbuds. It could be demonstrated that the sensor described herein can have a power consumption that is much smaller as compared to a capacitive sensor solution. The sensor described herein can be used as a stand-alone sensor or as supporting sensor in a group of sensors in order to obtain more precise and robust measurement results.

### BRIEF DESCRIPTION OF THE DRAWINGS

Further features, advantages and expediencies will become apparent from the following description of exemplary embodiments in conjunction with the figures.

FIG. 1A shows a schematic illustration of a sensor according to an embodiment,

FIG. 1B shows a schematic illustration of a sensor according to a further embodiment,

FIGS. 2A to 2F show schematic illustrations of a sensor in the absence and presence of various inputs according to a further embodiment,

FIGS. 3A and 3B show schematic illustrations of measurements performed in methods for operating a sensor according to several embodiments,

FIGS. 4A to 7D show schematic illustrations of a sensor according to further embodiments.

### DETAILED DESCRIPTION

In the embodiments and figures, identical, similar or identically acting elements are provided in each case with the same reference numerals. The elements illustrated and their size ratios to one another should not be regarded as being to scale, but rather individual elements, such as for example layers, components, devices and regions, may have been made exaggeratedly large to illustrate them better and/or to aid comprehension.

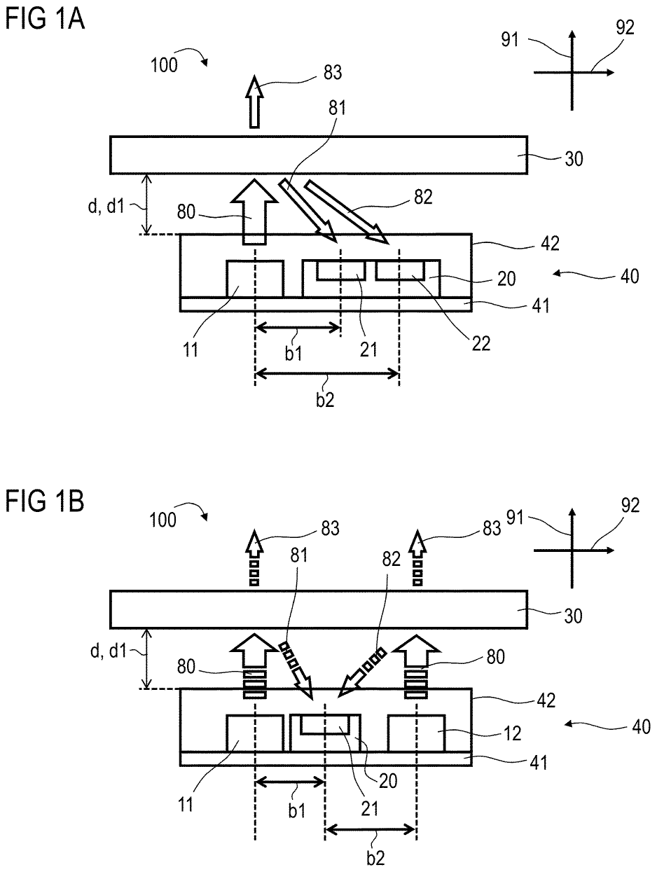

FIG. 1A shows an embodiment of a sensor 100 that comprises an emitter 11, a first detector 21 and a second detector 22. The emitter 11 and the first detector 21 form a first emitter-detector pair and the emitter 11 and the second detector 22 form a second emitter-detector pair. During operation of the sensor 100, the emitter 11 is operated to emit light with a predetermined wavelength. The light emitted by the sensor 100 will be denoted as sensor light in the following and is indicated in FIG. 1A by an arrow with the reference numeral 80. Each of the detectors 21, 22 is configured to detect the sensor light 80 and to output a signal that depends on the intensity of the sensor light impinging on the detector. Consequently, the sensor 100 comprises two emitter-detector pairs, wherein in the shown embodiment each of the emitter-detector pairs comprises the same emitter 11, configured to emit a sensor light 80, and a detector 21, 22, configured to detect the sensor light 80 and to produce an intensity signal. In particular, the sensor 100 is an all-optical sensor that is free of non-optical sensor devices like capacitive sensors and piezoelectric sensors.

The emitter 11 emits the sensor light 80 along a main emission direction that is denoted as vertical direction 91 in the following. Directions perpendicular to the vertical direction 91 are denoted as lateral directions 92. The sensor light 80 emitted by the emitter 11 can have a spectral component in the infrared, visible and/or ultraviolet wavelength range. In particular, the sensor light 80 can be infrared light or visible light or ultraviolet light.

For instance, the emitter 11 can be a vertically-emitting laser diode like a VCSEL (vertical-cavity surface-emitting laser). In this case, the light emission is mainly in the vertical direction 91. Alternatively, the emitter 11 can be a light-emitting diode, for instance. In this case, the emitter 11 can have a broader angular emission distribution and can emit, for instance, sensor light 80 with a Lambertian emission characteristic. By using one or more lenses or other optical elements (not shown) the emission characteristic of the emitter 11 can be adapted. Each of the detectors 21, 22 can be a photodiode. For instance, each detector 21, 22 can be a discrete photodiode or, as indicated in FIG. 1A, can be a part of an integrated detector chip 20 formed by a pixilated photodiode having several detection regions that form the detectors 21, 22 and that can be operated independently from each other. The emitter 11 and the detectors 21, 22 of the sensor 100 may be arranged in such a way that the emitter 11 cannot directly irradiate sensor light onto any detector 21, 22.

In the shown embodiment, the emitter 11 and the detectors 21, 22 are mounted and electrically connected on a carrier 41 which can be, for example, a printed-circuit board or a ceramic carrier or a package housing. Furthermore, as shown in FIG. 1A, the emitter 11 and detectors 21, 22 can be enclosed in a casting material 42 like a transparent plastic material such as silicone. Thus, the emitter 11, the detectors 21, 22, the carrier 41 and the casting material 42 can be part of a compact emitter-detector module 40 that is part of the sensor 100.

The vertical direction 91 may be a direction perpendicular to a mounting surface of a carrier 41 on which the emitter-detector pairs are arranged. The lateral directions 92 may be perpendicular to the mounting surface. Consequently, the emitter 11 and detector 21, 22 of each of the emitter-detector pairs are arranged along a lateral direction 92 and have a distance measured along that lateral direction. The distance between the emitter and detector of each of the emitter-detector pairs is also denoted as baseline b1, b2. Hence, the first emitter-detector pair of the sensor 100 has a first baseline b1 and the second emitter-detector pair of the sensor 100 has a second baseline b2, wherein the baseline b1, b2 of each of the emitter-detector pairs is defined by a distance between the emitter 11 of the emitter-detector pair and the detector 21, 22 of the same emitter-detector pair in a lateral direction 92. As indicated in FIG. 1A, the first baseline bl is different from the second baseline b2. The baselines b1, b2 can be, greater than or equal to 100 μm and less than or equal to 1 cm.

Furthermore, in addition to the emitter-detector module 40, the sensor 100 comprises a reflector 30. The reflector 30 may be partially reflective and partially light-transmissive for the sensor light 80 emitted by all of the emitters of the sensor 100. In other words, the reflector 30 partly reflects and partly transmits the sensor light 80 emitted by each of the emitters of the sensor 100.

The reflector 30 is arranged, along the vertical direction 91, over the emitter-detector module 40 and thus over all emitter-detector pairs of the sensor 100. In particular, in an idle state of the sensor 100, i.e. a state in which the sensor is not influenced by an external object, the reflector 30 is arranged at a predetermined distance, also denoted as height d in the following, from the emitter-detector pairs measured along the vertical direction 91. In particular, in the idle state the reflector 30 is not touched or pressed by an external object like a user's hand or finger, so that the reflector 30 has a first height dl along the vertical direction 91 in the idle state of the sensor 100. For instance, the height d of the reflector 30 can be measured along the vertical direction 91 from a mounting surface, onto which the emitter-detector pairs are mounted, or from an emission surface of the emitter 11 and/or from a detection surface of the detector 21, 22 of each of the emitter-detector pairs or, as shown in FIG. 1A, from an upper side of the casting material 42 that faces the reflector 30. Consequently, in the shown embodiment the height d is the distance between the emitter-detector module 40 and the reflector 30. The first height d1 can be equal to or greater than 100 μm and less than or equal to 1 cm.

The reflector 30 can be mounted, for instance, by means of a suitable supporting structure like a frame (not shown), to the same carrier 41 as the emitter 11 and the detectors 21, 22. Alternatively, the shown package comprising the emitter 11, the detectors 21, 22, the carrier 41 and the casting material 42 and the reflector can be arranged on a common housing (not shown). The arrangement and mounting of the reflector 30 is not limited, as long as the reflector 30 or at least a part of the reflector 30 can be moved or at least deformed towards the emitter-detector pairs. Thus, in the shown embodiment a gap is formed between the upper side of the casting material 42 and an underside of the reflector 30 facing the emitter 11 and detectors 21, 22, wherein the gap has a width corresponding to the first height d1 in the idle state of the sensor 100. Particularly, the reflector 30 can be bent by a user and/or moved by a user, in particular towards the emitter-detector pairs, so that the height d of the reflector 30 or of at least a part of the reflector 30 is reduced, so that a force input can cause a change in height d of at least a part of the reflector 30.

The reflector 30 comprises a plate-like part or, as shown in FIG. 1A, is formed as a plate. The reflector 30 can comprise a plastic or can be made of plastic, for instance ABS (acrylonitrile butadiene styrene). The material and the thickness of the reflector 30 are chosen such that the reflector 30 is partly reflective and partly light-transmitting in regard to the sensor light 80. For instance, the reflector 30 can have a thickness of greater than or equal to 200 μm and less than or equal to 2 mm. The reflector 30 may be white. Particularly, the reflector 30 has a reflectivity of equal to or greater than 75% and equal to or less than 99% for the sensor light 80 emitted by at least one of the emitters or more than one emitter or all emitters of the sensor 100, which can be one or more emitters. Furthermore, the reflector 30 has a light-transmission of equal to or greater than 1% and equal to or less than 25% for the sensor light 80. The reflector 30 can be diffusive reflective or mirror-like reflective.

As indicated in a further embodiment shown in FIG. 1B, the sensor 100 can comprise more than one emitters 11, 12 and a detector 21, so that each emitter-detector pair is formed by an emitter 11 of the more than one emitters 11, 12 and the same detector 21, so that all emitter-detector pairs can share the same detector 21. Also, in this case the sensor 100 comprises a first emitter-detector pair having a first baseline b1 and a second emitter-detector pair having a second baseline b2 that may be different from the first baseline b1. As shown in FIG. 1B, in this case the first and second emitter 11, 12 can emit light pulses. Each of the first and second emitters 11, 12 may be configured to emit light pulses of the same sensor light 80, and the first emitter 11 emits the light pulses at different times than the second emitter 12 so that the detector 21 can distinguish between light pulses from the first emitter 11 and from the second emitter 12.

As shown in FIGS. 1A and 1B, during operation of the emitter-detector pairs in the idle state of the sensor 100, for the first emitter-detector pair a first part 81 of the sensor light 80 emitted by the emitter of the first emitter-detector pair is reflected by the reflector 30 onto the detector of the first emitter-detector pair, so that the detector of the first emitter-detector pair produces a first intensity signal. Similarly, for the second emitter-detector pair a second part 82 of the sensor light 80 emitted by the emitter of the second emitter-detector pair is reflected by the reflector 30 onto the detector of the second emitter-detector pair, so that the detector of the second emitter-detector pair produces a second intensity signal. Additionally, a part of the sensor light 80 that is denoted as transmitted light 83, is transmitted through the reflector 30

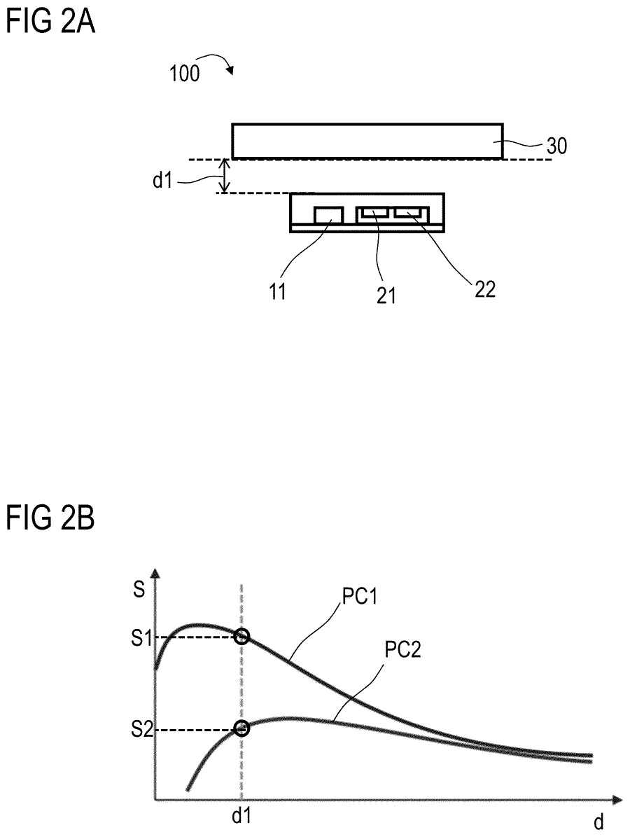

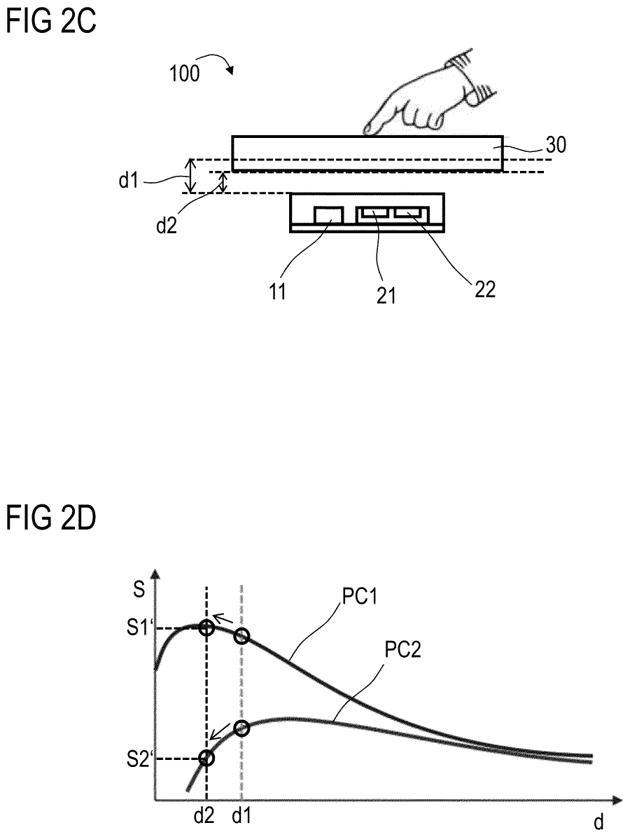

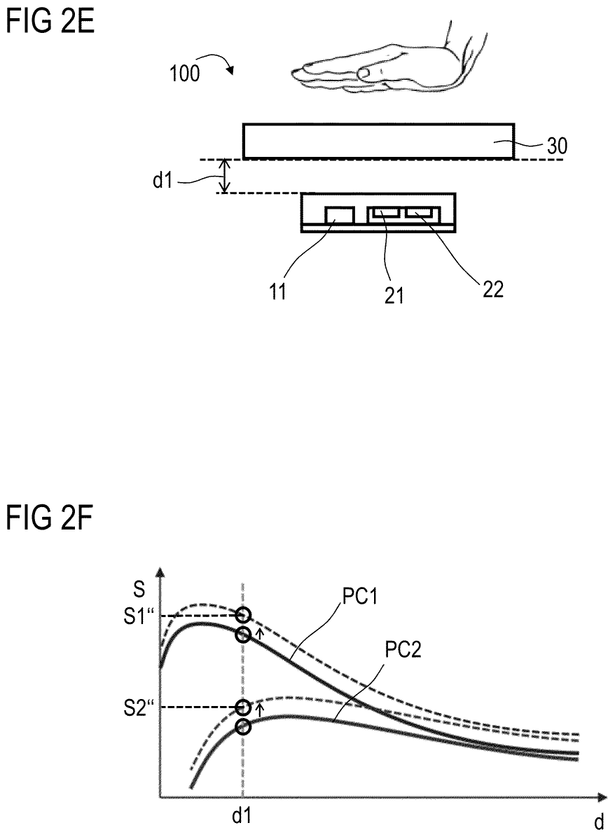

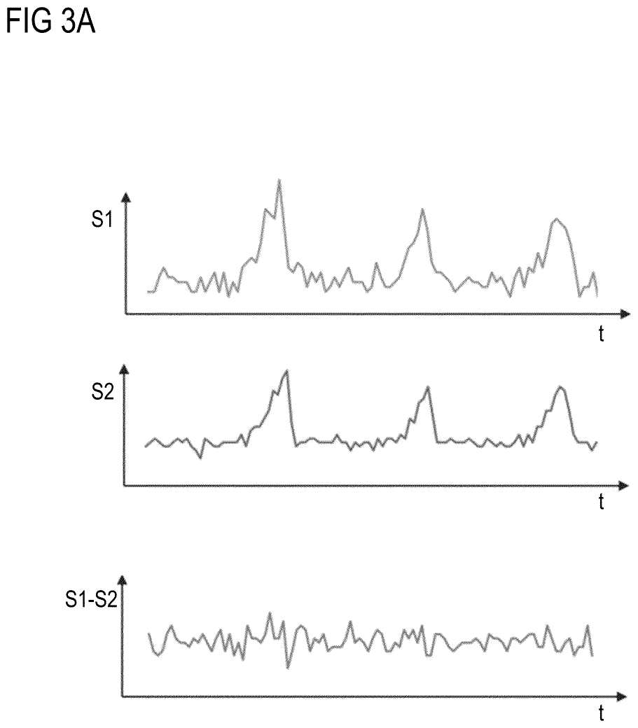

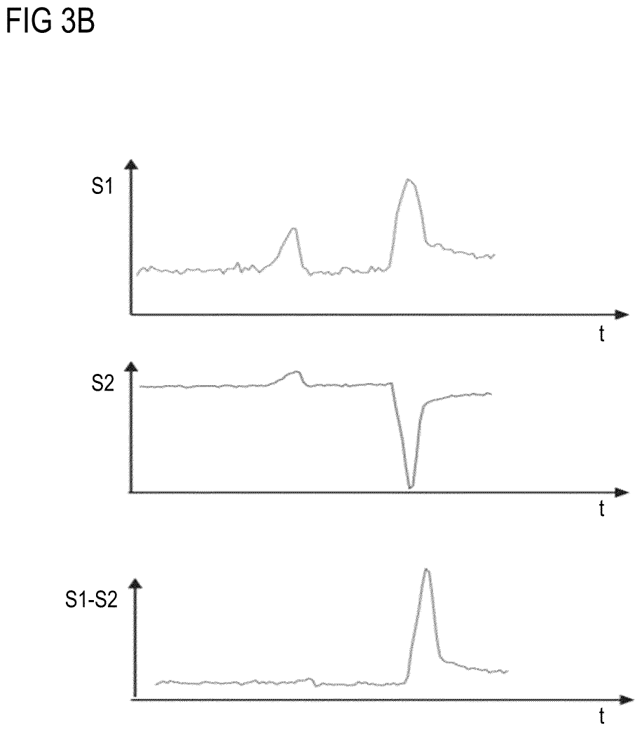

The sensor 100 is configured for detecting gesture inputs and force inputs. In other words, the sensor 100 is used in a method for operating the sensor for detecting gesture and force inputs as described in connection with FIGS. 2A to 3B.

By way of example only, in FIGS. 2A to 2F the sensor 100 of the embodiment shown in FIG. 1A is indicated. Alternatively, the sensor could be configured as shown in FIG. 1B, so that the following description analogously applies to the embodiment of FIG. 1B.

In FIG. 2A, the sensor 100 is shown in the idle state. For the sake of clarity, not all elements of the sensor 100 are denoted by reference numerals, so that the description of FIGS. 2A to 2F also refers to FIG. 1A. FIG. 2B which shows the dependency of the signal strength of the intensity signal S measured by the detectors 21, 22 from the height d.

As shown in FIG. 2B, in the idle state the first detector 21 produces a first intensity signal with a first signal strength S1 and the second detector 22 produces a second intensity signal with a second signal strength S2 depending on the part of the sensor light that is reflected onto the respective detector 21, 22. Depending on the height d of the reflector 30 the intensity signal S changes as indicated in FIG. 2B. In particular, the first height d1 as well as the first baseline b1 and the second baseline b2 as described in connection with FIGS. 1A and 1B are chosen such that the first baseline b1 determines a first characteristic proximity curve PC1 defining a dependency of the first intensity signal from the height d of the reflector 30 and the second baseline b2 determines a second characteristic proximity curve PC2 defining a dependency of the second intensity signal from the height d of the reflector 30 as indicated in FIG. 2B. Each of the characteristic proximity curves PC1, PC2 has a maximum at a certain height d of the reflector 30, which depends on the respective baseline b1, b2. For example, the first baseline b1 is chosen such that, in the idle state, the maximum of the first characteristic proximity curve PC1 is at a lower height than the first height d1 and may be at a lower height than the second height d2, whereas the second baseline b2 is chosen such that, in the idle state, the maximum of the second characteristic proximity curve PC2 is at a greater height than the first height d2. Consequently, when the height d of the reflector 30 or of at least a part of the reflector 30 is reduced, the first part 81 of the sensor light 80 that is reflected on the first detector 21 of the first emitter-detector pair increases, whereas the second part 82 of the sensor light 80 that is reflected on the second detector 22 of the second emitter-detector pair decreases.

When a force input occurs, which means that, as shown in FIG. 2C, an object like a user's finger presses onto the reflector 30 so that the height d of at least a part of the reflector 30 decreases from the first height d1 to a second height d2 that is less than the first height d1, the first part 81 of the sensor light 80 and the second part 82 of the sensor light 80 change due to the change in the geometrical relation between the reflector 30, the emitter 11 and the detectors 21, 22 of the emitter-detector pairs. As described before, the first height d1 of the reflector, the first baseline b1 of the first emitter-detector pair and the second baseline b2 of the second emitter-detector pair are chosen so that, when the whole reflector 30 or at least a part of the reflector 30 is moved from the first height d1 to a second height d2 that is less than the first height d1, the first part 81 of the sensor light 80 is increased and the second part 82 of the sensor light 80 is decreased. In other words, when the reflector 30 or at least a part of the reflector 30 is at the second height d1, in comparison to the idle state more sensor light 80 is reflected onto the detector 21 of the first emitter-detector pair and less sensor light 80 is reflected onto the detector 22 of the second emitter-detector pair. Consequently, as shown in FIG. 2D when the reflector 30 or at least a part of the reflector 30 is at the second height d1, the first detector 21 outputs a first signal strength S1′ of the first intensity signal of the first emitter-detector pair that is increased and the second detector 22 outputs a second signal strength S2′ of the second intensity signal of the second emitter-detector pair that is decreased in comparison to the first and second signal strengths S1, S2 that are produced in the idle state.

When a gesture input occurs, which means, as shown in FIG. 2E, that an object like a user's finger or hand is present over or on the reflector, as seen from the emitter-detector pairs, but does not press onto the reflector 30 and, thus, does not reduce the height d1 of the reflector 30 or of at least a part of the reflector 30, at least a part of the transmitted part 83 of the sensor light 80 that is transmitted through the reflector can be reflected by the object back through the reflector and onto the detectors 21, 22 of the emitter-detector pairs. Consequently, in comparison to the idle state of the sensor 100 when the object is absent, more sensor light 80 is irradiated onto the detector 21 of the first emitter-detector pair and more sensor light 80 is irradiated onto the detector 22 of the second emitter-detector pair. Therefore, as shown in FIG. 2F, the characteristic proximity curves PC1 and PC2 are shifted to higher intensities. Consequently, the first detector 21 outputs a first signal strength S1″ of the first intensity signal and the second detector 22 outputs a second signal strength S2″ of the second intensity signal, wherein both the first and second signal strength S1″, S2″ are increased in comparison to the signal strengths S1, S2 in the idle state.

In the method for operating the sensor, the first emitter-detector pair and the second emitter-detector pair are operated at the same time or subsequently, so that the first emitter-detector pair produces the first intensity signal having a first signal strength and the second emitter-detector pair produces the second intensity signal having a second signal strength. As shown in FIGS. 3A and 3B, the first intensity signal is observed for changes in the first signal strength S1 and the second intensity signal is observed for changes in the second signal strength S2. Observing an intensity signal for changes in a signal strength can in particular mean that signal strength variations with time t are observed. Furthermore, a difference signal of the first intensity signal and the second intensity signal is calculated and the difference signal is observed for changes in a difference signal strength S1−S2.

FIG. 3A shows a measurement of a gesture input that occurs at three different times. As explained above, the signal strength S1, S2 of both the first intensity signal and of the second intensity signal increase due to the gesture inputs, thus resulting in peaks in the signal strengths S1, S2. In the difference signal of the first intensity signal and the second intensity signal, however, the changes in the first and second signal strength S1, S2 at least partly cancel each other out, so that the amplitude of the change in the difference signal strength S1−S2 is smaller than the amplitudes of the changes in the first and second signal strengths S1, S2.

FIG. 3B shows a similar measurement of first a gesture input and then a force input that occurs after the gesture input. As described above, the force input causes an increase of the first signal strength S1 and a decrease of the second signal strength S2. Consequently, in the difference signal of the first intensity signal and the second intensity signal, the changes in the first and second signal strength S1, S2 caused by the force input sum up and do not cancel each other out, so that the change in the difference signal strength S1−S2 is greater than the changes in the first and second signal strengths S1, S2. The variations caused by the gesture input, however, are hardly detectable anymore in the difference signal strength S1−S2 as described in connection with FIG. 3A. Thus, a force input on the reflector that causes the height change of the reflector can be identified in the difference signal.

Consequently, both a force input and a gesture input can be detected, wherein the gesture input can be distinguished from the force input. Thus, the sensor 100 described herein uses optimized detector-emitter geometries and can perform triangulation on the received signals to detect both force and gesture inputs.

In contrast to the embodiments described in connection with FIGS. 1 to 3B, the sensor 100 can comprise an emitter in combination with more than two detectors or a detector in combination with more than two emitters.

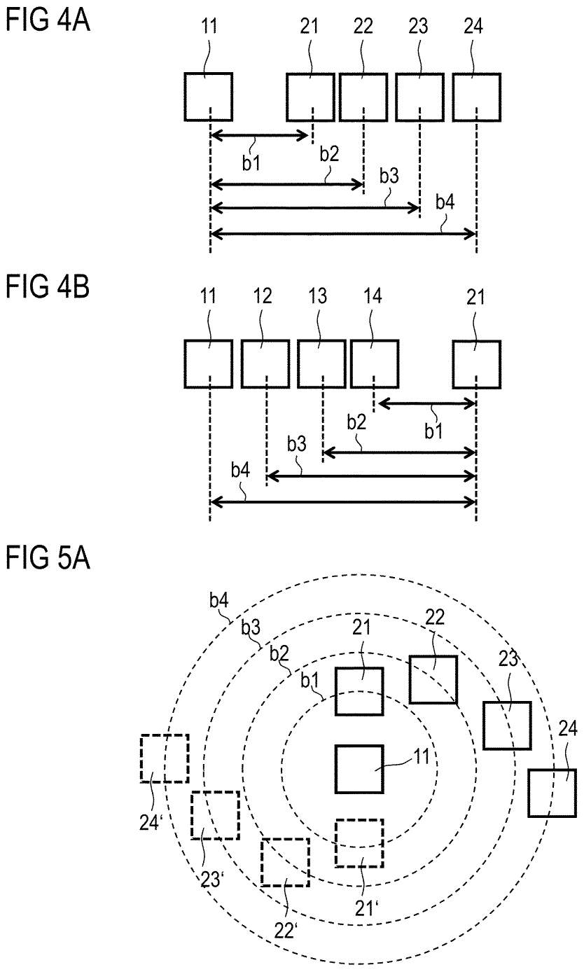

For example, as shown in FIG. 4A, the sensor can comprise an emitter 11 and four detectors 21, 22, 23, 24 that are arranged along a straight line along the lateral direction, wherein the emitter 11 and each of the detectors 21, 22, 23, 24 forms an individual emitter-detector pair with a baseline b1, b2, b3, b4 that is different from the baselines of all the other emitter-detector pairs. It can also be possible, as shown in FIG. 4B, that the sensor comprises four emitters 11, 12, 13, 14 and a detector 21 that are arranged along a straight line along the lateral direction, wherein each of the emitters 11, 12, 13, 14 and the detector 21 forms an individual emitter-detector pair with a baseline b1, b2, b3, b4 that is different from the baselines of all the other emitter-detector pairs. Each of the emitter-detector pairs in the embodiments shown in FIGS. 4A and 4B has its own specific characteristic proximity curve so that, depending on the parameters of the force and gesture inputs more information can be gathered for the triangulation method described before that can lead to a more precise measurement and interpretation of the input.

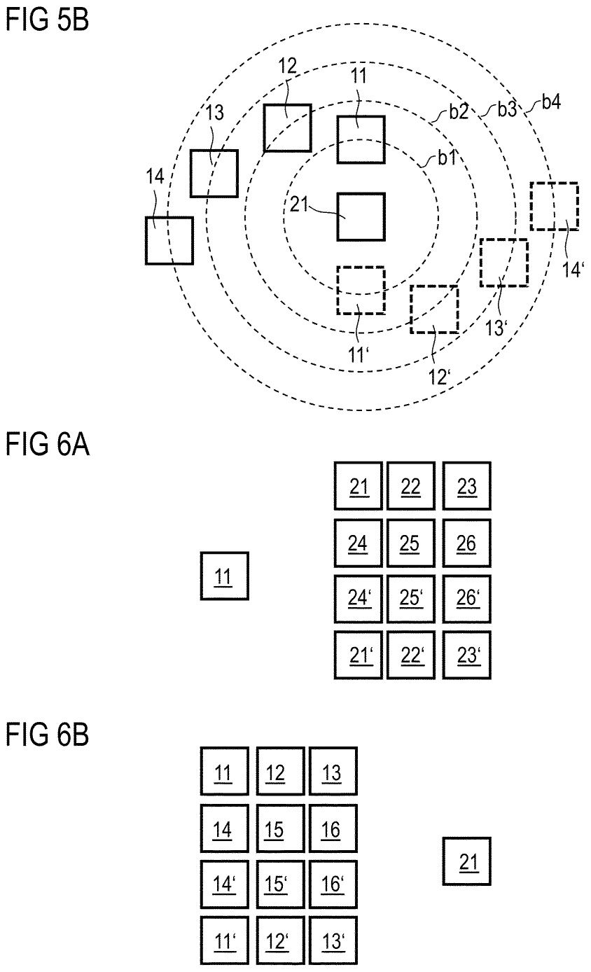

As shown in FIGS. 5A and 5B, the plurality of detectors 21, 22, 23, 24 or the plurality of emitters 11, 12, 13, 14 can also be arranged along a non-straight line, as long as the baselines b1, b2, b3, b4, indicated by the dashed circles, of the emitter-detector pairs are different. Furthermore, as indicated by the dashed boxes, it can be possible that more detectors 21′, 22′, 23′, 24′ or emitters 11′, 12′, 13′, 14′ are used that lead to groups of emitter-detector pairs with the same baselines b1, b2, b3, b4. In the shown embodiments of FIGS. 5A and 5B, using the additional detectors 21′, 22′, 23′, 24′ or emitters 11′, 12′, 13′, 14′ indicated by the dashed boxed would lead to four groups of two emitter-detector pairs each that have the same baseline and, thus, the same or nearly the same characteristic proximity curves. This can lead, for instance, to a higher degree of redundancy and/or a better signal-to-noise ratio.

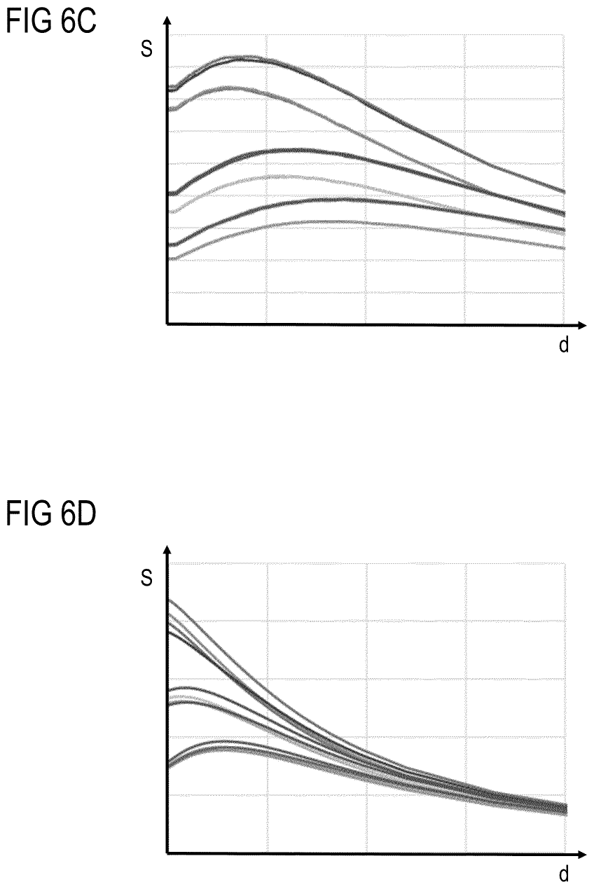

In connection with FIGS. 6A and 6B further embodiments of the sensor are indicated, wherein the sensor can comprise for instance six groups of two emitter-detector pairs each with a same baseline by arranging twelve detectors 21, 22, 23, 24, 25, 26, 21′, 22′, 23′, 24′, 25′, 26′ (FIG. 6A) or arranging twelve emitters 11, 12, 13, 14, 15, 16, 11′, 12′, 13′, 14′, 15′, 16′ (FIG. 6B) in a matrix-like array symmetrically to the emitter or detector, respectively. FIGS. 6C and 6D show the resulting characteristic proximity curves for the embodiment showing in FIG. 6A, when a VCSEL (FIG. 6C) or an LED (FIG. 6D) is used as emitter 11.

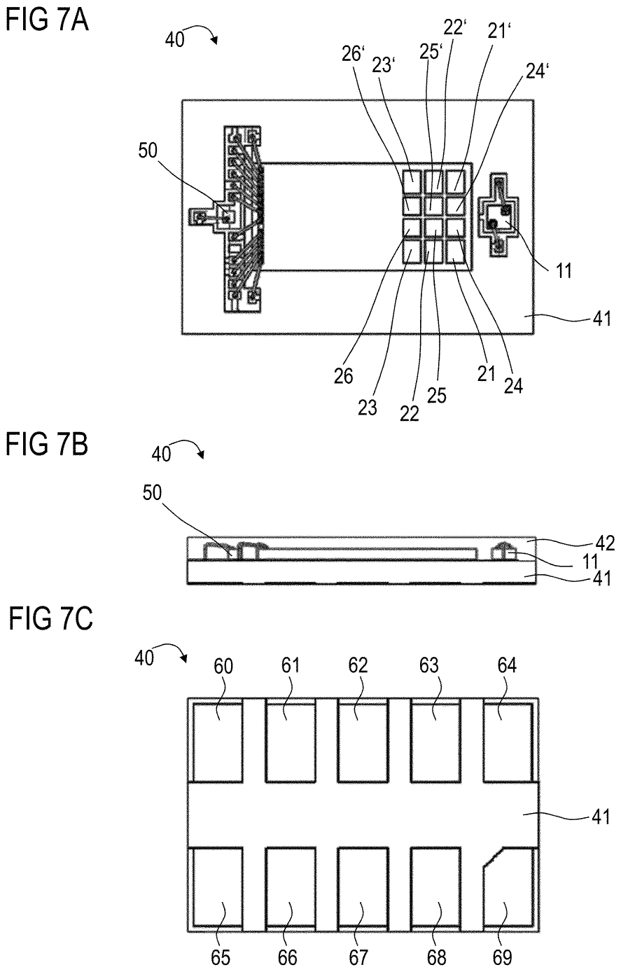

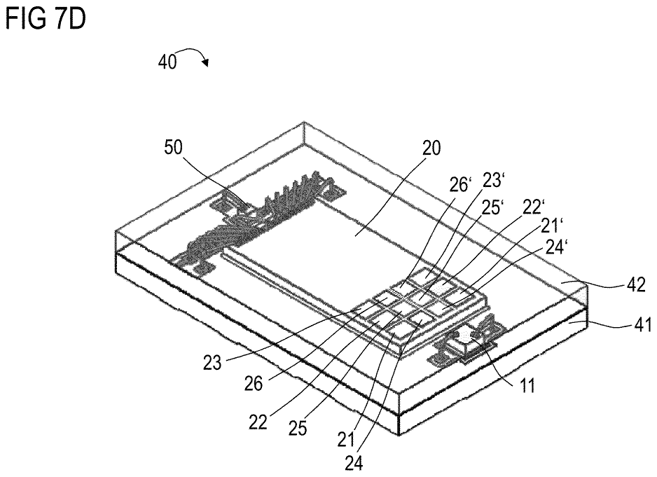

FIGS. 7A to 7D show various views of an emitter-detector module 40 of a sensor that is similar to the embodiment shown in FIG. 1A but has one emitter 11 and twelve detectors 21, 22, 23, 24, 25, 26, 21′, 22′, 23′, 24′, 25′, 26′ according to the embodiment of FIG. 6A. The detectors 21, 22, 23, 24, 25, 26, 21′, 22′, 23′, 24′, 25′, 26′ are parts of an integrated detector chip 20 having various detection segments forming the detectors 21, 22, 23, 24, 25, 26, 21′, 22′, 23′, 24′, 25′, 26′. Furthermore, it can be possible that the detector chip 20 provides some integrated logic for controlling the emitter chip 11, measuring the intensity signals of the detectors 21, 22, 23, 24, 25, 26, 21′, 22′, 23′, 24′, 25′, 26′ and calculating various difference signals from the various intensity signals. An ESD (electrostatic discharge) protection chip 50 can also be present. Via contacts 60, 61, 62, 63, 64, 65, 66, 67, 68, 69 on the underside of the carrier 41 the emitter-detector module 40 can be mounted on an external carrier and electrically contacted.

Alternatively or additionally to the features described in connection with the figures, the embodiments shown in the figures can comprise further features described in the general part of the description. Moreover, features and embodiments of the figures can be combined with each other, even if such combination is not explicitly described.

The invention is not restricted by the description on the basis of the exemplary embodiments. Rather, the invention encompasses any new feature and also any combination of features, which in particular comprises any combination of features in the patent claims, even if this feature or this combination itself is not explicitly specified in the patent claims or exemplary embodiments.

### REFERENCES

11, 12, 13, 14, 15, 16 emitter
11′, 12′, 13′, 14′, 15′, 16′ emitter
20 integrated detector chip
21, 22, 23, 24, 25, 26 detector
21′, 22′, 23′, 24′, 25′, 26′ detector
30 reflector
40 emitter-detector module
41 carrier
42 casting material
50 ESD protection chip
60, 61, 62, 63, 64, 65, 66, 67, 68, 69 contact
80 sensor light
81 first part
82 second part
83 transmitted part
91 vertical direction
92 lateral direction
100 sensor
b1, b2, b3, b4 baseline
d, d1, d2 height
PC1, PC2 proximity curve
S intensity signal
S1, S2, S1′, S2′, S1″, S2″ signal strength

1. An all-optical sensor for detecting gesture inputs and force inputs, the sensor comprising:
at least two emitter-detector pairs comprising a first emitter-detector pair and a second emitter-detector pair, each emitter-detector pair of the sensor comprising an emitter and a detector, and
a reflector,
wherein
the emitter of each emitter-detector pair is configured to emit a sensor light with a main emission direction at least substantially parallel to a vertical direction,
the detector of each emitter-detector pair is configured to detect the sensor light emitted by the emitter of the same emitter-detector pair,
the reflector is partially reflective and partially light-transmissive for the sensor light emitted by all of the emitters of the sensor,
the first emitter-detector pair has a first baseline and the second emitter-detector pair has a second baseline,
the baseline of each of the emitter-detector pairs is defined by a distance between the emitter of the emitter-detector pair and the detector of the emitter-detector pair in a lateral direction,
the reflector is arranged, along the vertical direction, over all emitter-detector pairs of the sensor and has a first height along the vertical direction in an idle state of the sensor, so that for the first emitter-detector pair a first part of the sensor light emitted by the emitter of the first emitter-detector pair is reflected by the reflector onto the detector of the first emitter-detector pair, the detector of the first emitter-detector pair producing a first intensity signal, and so that for the second emitter-detector pair a second part of the sensor light emitted by the emitter of the second emitter-detector pair is reflected by the reflector onto the detector of the second emitter-detector pair, the detector of the second emitter-detector pair producing a second intensity signal,
the first height, the first baseline and the second baseline are chosen so that, when at least a part of the reflector is moved from the first height to a second height that is less than the first height, the first part of the sensor light is increased and the second part of the sensor light is decreased.

2. The sensor according to claim 1, wherein the sensor comprises at least one emitter and at least a first detector and a second detector, the at least one emitter and the first detector forming the first emitter-detector pair and the at least one emitter and the second detector forming the second emitter-detector pair.

3. The sensor according to claim 2, wherein the at least one emitter is configured to continuously emit the sensor light.

4. The sensor according to claim 2, wherein the at least one emitter is configured to emit light pulses.

5. The sensor according to claim 1, wherein the sensor comprises a first emitter and a second emitter and at least one detector, the first emitter and the at least one detector forming the first emitter-detector pair and the second emitter and the at least one detector forming the second emitter-detector pair.

6. The sensor according to claim 5, wherein the first and second emitters are configured to emit light pulses.

7. The sensor according to claim 6, wherein
each of the first and second emitters are configured to emit light pulses of the same sensor light, and
the first emitter emits the light pulses at different times than the second emitter.

8. The sensor according to claim 1, wherein
the first baseline determines a first characteristic proximity curve defining a dependency of the first intensity signal from the height of the reflector,
the second baseline determines a second characteristic proximity curve defining a dependency of the second intensity signal from the height of the reflector,
the first characteristic proximity curve has a maximum at a height that is less than the second height, and
the second characteristic proximity curve has a maximum at a height that is greater than the first height.

9. The sensor according to claim 8, wherein the first baseline is different from the second baseline.

10. The sensor according to claim 1, wherein all emitters and all detectors of the sensor are arranged in such a way that no emitter can directly irradiate sensor light onto any detector.

11. The sensor according to claim 1, wherein the reflector comprises a plate-like part or is formed as a plate.

12. The sensor according to claim 1, wherein the reflector has a reflectivity of equal to or greater than 75% and equal to or less than 99% for the sensor light.

13. The sensor according to claim 1, wherein the reflector has a light-transmission of equal to or greater than 1% and equal to or less than 25% for the sensor light.

14. The sensor according to claim 1, wherein the reflector can be bent and/or moved by a user toward the emitter-detector pairs.

15. The sensor according to claim 1, wherein at least one emitter of the sensor is a vertically-emitting laser diode.

16. The sensor according to claim 1, wherein at least one emitter of the sensor is a light-emitting diode.

17. The sensor according to claim 1, wherein at least one detector of the sensor is a photodiode.

18. A method for operating a sensor according to claim 1, for detecting gesture and force inputs,
wherein the first emitter-detector pair and the second emitter-detector pair are operated at the same time or subsequently, so that the first emitter-detector pair produces the first intensity signal having a first signal strength and the second emitter-detector pair produces the second intensity signal having a second signal strength,
wherein each of the first intensity signal is observed for changes in the first signal strength and the second intensity signal is observed for changes in the second signal strength,
wherein a difference signal of the first intensity signal and the second intensity signal is calculated and the difference signal is observed for changes in a difference signal strength.
